(19) United States
(12) Patent Application Publication
(10) Pub. No.: US 2002/0067528 A1
(43) Pub. Date: Jun. 6, 2002

(54) Optical transceiver

(76) Inventors: Michael Loddoch, Hildesheim (DE); Hans Kragl, Diekholzen (DE)

Correspondence Address: HAYES, SOLOWAY, HENNESSEY, GROSSMAN & HAGE, P.C., 130 W. Cushing Street, Tucson, AZ, 85701, US

(21) Appl. No.: 09/911,067

(22) Filed: Jul. 23, 2001

(30) Foreign Application Priority Data
Jul. 28, 2000 (DE) 200 13 088.9

(51) Int. Cl. H04B 10/00

(52) U.S. Cl. 359/152; 359/163

(57) ABSTRACT

An optical transceiver comprises a housing, a circuit board produced by formation technology and provided with conductor tracks, at least one optical fiber coupled with the circuit board, and a plurality of electrically conductive contact elements which are connected with the conductor tracks of the circuit board in an electrically conductive manner.

### TECHNICAL FIELD

The invention relates to an optical transceiver.

### BACKGROUND OF THE INVENTION

Optical transceivers are used for converting optical signals into electrical signals, and vice versa. The optical signals are provided by means of at least one optical light guide fiber.

The object of the invention is to improve a transceiver to the effect that it may be employed by a user without the latter having to familiarize himself with the special installation technology for optical waveguides.

### BRIEF SUMMARY OF THE INVENTION

This is achieved in an optical transceiver which comprises a housing, a circuit board produced by formation technology and provided with conductor tracks, at least one optical fiber coupled with the circuit board, and a plurality of electrically conductive contact elements which are connected with the conductor tracks of the circuit board in an electrically conductive manner.

By using a circuit board produced by means of formation technology, a very compact structure of the transceiver is made possible, because both optical conductor tracks in the shape of waveguide trenches and electrical conductor tracks in the shape of partial metallizations are able to be integrated in the circuit board formed. The structure of such a circuit board is known, for example, from German Patent Applications 198 51 265 or 198 61 162, which in detail show the details of manufacture of such a circuit board and which are incorporated into the subject application by reference. Due to the circuit board being compact, the housing may be designed so as to have very small dimensions, e.g. as a plug housing for a plug of the type RJ-45. The contact elements, which for instance can be plug contacts, correspond to the usual contacts of such a plug. The user inserts the transceiver into an associated socket just like a conventional plug, whilst not being involved in handling optical components and not taking notice of the employment of an optical transmission path, because the interface is still an electrical plug connector.

Advantageous embodiments of the invention will be apparent from the subclaims.

### BRIEF DESCRIPTION OF THE DRAWINGS

FIG. 1 shows an optical transceiver in a side view;

FIG. 2 shows the transceiver of FIG. 1 in a top view;

FIG. 3 shows the transceiver of FIG. 1 in a front view;

FIG. 4 shows the transceiver of FIG. 1 in a perspective bottom view;

FIG. 5 shows the transceiver of FIG. 1 in a perspective top view;

FIG. 6 shows in a perspective view the circuit board including a plug contact, as used with the transceiver of FIG. 1.

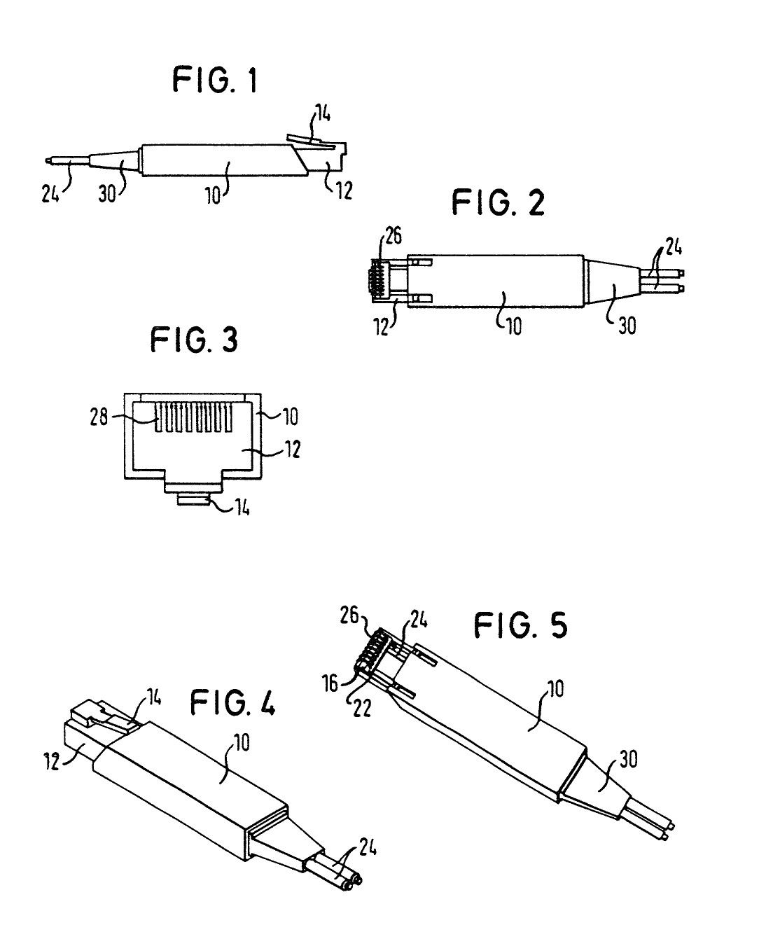

### DETAILED DESCRIPTION OF THE PREFERRED EMBODIMENT

The transceiver according to the invention as illustrated in the drawings is designed as a plug connector of the type RJ-45. It is to be noted, however, that it may also be designed as a plug connector of any other type.

The plug connector has a housing which is comprised of an outer part 10 which may serve as a handle piece, and of an inner part 12. The inner part is provided with a snap-in hook 14 by means of which the plug connector can be locked in place in a plug socket.

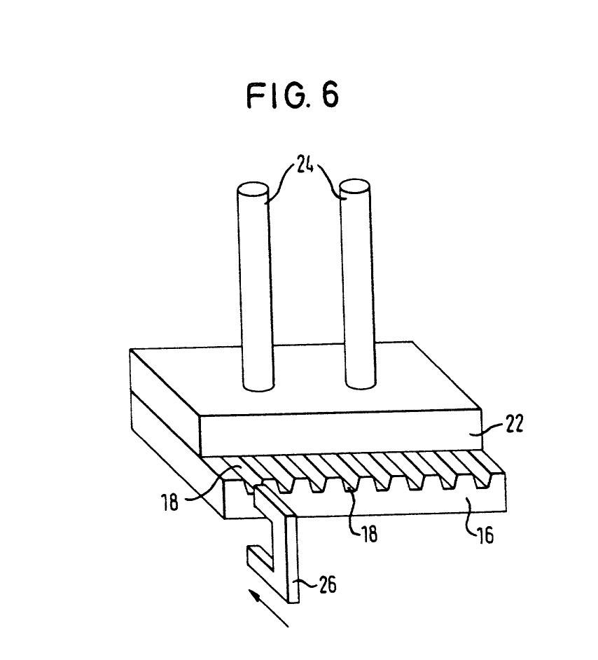

A circuit board 16, shown scaled-up in FIG. 6, is arranged on the inner part 12 of the housing. The circuit board 16 is produced in formation technology, as described in the two above mentioned patent applications, and has electrical conductor tracks 18 formed by partially metallized areas of the circuit board. Further, the circuit board has optical conductor tracks which are not to be seen in the Figures. These optical conductor tracks are realized by waveguide trenches filled up with a suitable material. The circuit board 16 is further provided with opto-electronic components (not to be seen in FIG. 6), which are mounted to the circuit board so as to be precisely aligned and which are connected in a suitable fashion with the optical and electrical conductor tracks, respectively.

A cover plate 22 is placed on the circuit board 16, this plate being provided with two receiving holes for two optical fibers 24. The two receiving holes extend perpendicularly to the plane of extension of the cover plate 22. The cover plate 22 is precisely aligned in relation to the circuit board 16 by means of suitable adjustment and positioning formations such as pyramid-shaped protrusions and complementary recesses, so that the two optical fibers 24 are coupled precisely with the associated opto-electronic components.

In a region adjoining the peripheral area of the circuit board 16, the electrical conductor tracks 18 are formed as grooves the surface of which is metallized. One plug contact 26 each is inserted in the grooves, the plug being configured as a U-shaped stirrup. One of the legs of the stirrup is connected with the electrical conductor track, either by a simple sticking-on or also by soldering, whilst the opposite leg is accommodated in recesses 28 which are formed in the end face of the inner part 12, it is in this way that the connecting land between the two legs lies freely exposed as a contact surface area on the outer side of the inner part 12, so that they can be contacted by contacts of the plug socket. The design of the plug contacts 26 and the special arrangement results in an improved mechanical support of the circuit board 16 on the rear face of the end face of inner part 12.

The outer part 10 is provided on its rear side with a bend protection sleeve 30 which prevents that the optical fiber is sharply bent upon exiting the plug connector.

As an alternative to the embodiment illustrated there can be provided for that a 1×2 fiber joint is integrated in the housing, so that a bidirectional data traffic is possible via one single optical fiber. The fiber joint may either be realized as a separate component in the housing or so as to be integrated in the circuit board.

According to an alternative embodiment there can be used, instead of the separate plug contacts stuck to the circuit board, a plurality of suitably metallized areas of the circuit board which are contacted directly.

1. An optical transceiver comprising a housing, a circuit board produced by formation technology and provided with conductor tracks, at least one optical fiber coupled with said circuit board, and a plurality of electrically conductive contact elements which are connected with said conductor tracks of said circuit board in an electrically conductive manner.

2. The transceiver according to claim 1, wherein a cover plate is provided which is placed on said circuit board and in which said optical fiber is accommodated.

3. The transceiver according to claim 2, wherein said cover plate is provided with a receiving hole for receiving said optical fiber, said receiving hole extending perpendicularly to a plane of extension of said cover plate.

4. The transceiver according to claim 1, wherein said circuit board is equipped with opto-electronic components.

5. The transceiver according to claim 1, wherein said contact elements are separate plug contacts.

6. The transceiver according to claim 5, wherein said plug contacts are stuck to said conductor tracks.

7. The transceiver according to claim 6, wherein said circuit board has a plurality of grooves which are provided with a metallization and in which said plug contacts are accommodated.

8. The transceiver according to claim 1, wherein said housing is comprised of an outer part and an inner part, said inner part being connected with said circuit board and provided with a snap-in hook, so that said transceiver may be locked in place in a counterpiece.

9. The transceiver according to claim 1, wherein said plug contacts having two legs each are designed to be U-shaped and arranged such that said circuit board and an end face of said housing lie between said legs and are held in contact with each other.

10. The transceiver according to claim 1, wherein it is constructed as a plug.

11. The transceiver according to claim 10, wherein it is a plug of the type RJ-45.

12. The transceiver according to claim 1, wherein two optical fibers are provided.

13. The transceiver according to claim 1, wherein there are provided a 1×2 fiber joint as well as a single optical fiber for a bidirectional data traffic.
